(19) United States
(12) Patent Application Publication
(10) Pub. No.: US 2021/0345133 A1
(43) Pub. Date: Nov. 4, 2021

(54) METHOD AND DEVICE FOR CONFIGURING NETWORK PARAMETER, AND COMPUTER-READABLE STORAGE MEDIUM

(71) Applicant: Beijing Xiaomi Mobile Software Co., Ltd., Beijing (CN)

(72) Inventor: Yanhua LI, Beijing (CN)

(21) Appl. No.: 17/284,210

(22) PCT Filed: Oct. 24, 2018
(86) PCT No.: PCT/CN2018/111738

§ 371 Date: Apr. 9, 2021

(51) Int. Cl. H04W 24/02

(52) U.S. Cl. CPC H04W 24/02

(57) ABSTRACT

Disclosed are a method and apparatus for configuring a network parameter, and a computer-readable storage medium, relating to the field of communication technologies. The method includes: in response to detecting a trigger event, determining a network parameter adjustment instruction by a terminal device based on the trigger event; sending the network parameter adjustment instruction to a base station, the network parameter adjustment instruction instructing the base station to adjust a network configuration parameter between the base station and the terminal device. The terminal device determines the network parameter adjustment instruction by means of the trigger event, so as to adjust the network configuration parameter of the terminal device side based on the network parameter adjustment instruction, and sends the determined network parameter adjustment instruction to the base station, such that the base station can also adjust the network configuration parameter according to the network parameter, thereby realizing the same network parameter configurations of the base station and the terminal device to ensure data transmission. The solution does not require the terminal device to upload the trigger event prior to receiving the network parameter configuration instructed by the base station, thereby achieving a quick network configuration process.

### TECHNICAL FIELD

The present disclosure relates to the field of communication technologies, and in particular, relates to a method and apparatus for configuring a network parameter, and a computer-readable storage medium.

### BACKGROUND

In a long-term evolution (LTE) network, a base station and a terminal device need to adopt the same network parameter configuration to ensure normal data transmission between the base station and the terminal device.

An existing network parameter configuring process is described as follows: the terminal device reports assistant information to the base station; the base station determines a network parameter configuration for the terminal device based on the assistant information; then the base station instructs, via a radio resource control (RRC) signaling, the terminal device to be configured with a network parameter; wherein the assistant information indicates configuration requirements of the terminal device.

In the above technical solution, a user reports assistant information first, such that the entire network parameter configuring process is slow.

### SUMMARY

The present disclosure provides a method and apparatus for configuring a network parameter, and a computer-readable storage medium, which can facilitate a process of configuring a network parameter.

According to a first aspect of the embodiments of the present disclosure, a method for configuring a network parameter is provided. The method includes: in response to detecting a trigger event, determining a network parameter adjustment instruction by a terminal device based on the trigger event of the terminal device; and sending the network parameter adjustment instruction to a base station, the network parameter adjustment instruction instructing the base station to adjust a network configuration parameter between the base station and the terminal device.

In the embodiments of the present disclosure, the terminal device determines the network parameter adjustment instruction based on the trigger event, and adjusts a network configuration parameter of the terminal device side based on the network parameter adjustment instruction. At the same time, the terminal device sends the determined network parameter adjustment instruction to the base station, such that the base station can also adjust the network configuration parameter between the base station and the terminal device based on the network parameter adjustment instruction, thereby realizing the same network parameter configurations of the base station and the terminal device to ensure data transmission. The solution does not require the terminal device to upload the trigger event prior to receiving the network parameter configuration instructed by the base station, thereby achieving a faster network configuration process.

In one embodiment of the present disclosure, determining the network parameter adjustment instruction by the terminal device based on the trigger event includes: determining, based on a corresponding relationship between the trigger event and the network configuration parameter, a network configuration parameter corresponding to the trigger event of the terminal device; and determining the network parameter adjustment instruction based on the network configuration parameter and a network configuration parameter being used by the terminal device.

In this embodiment, the terminal device determines a network configuration parameter corresponding to the trigger event of the terminal device based on a pre-configured corresponding relationship between the trigger event and the network configuration parameter, and then determines the network parameter adjustment instruction based on the network configuration parameter and a network configuration parameter being used by the terminal device. This embodiment is simple and practicable.

In another embodiment of the present disclosure, the trigger event includes a radio link failure event detected by the terminal device and a measurement event executed by the terminal device.

In this embodiment, if the trigger event indicates that a power preference indication of the terminal device is changed, a network configuration meeting the user's power preference indication may be determined based on this trigger event. If the trigger event is a radio link failure event detected by the terminal device or a measurement event executed by the terminal device, better communication between the terminal device and the base station may be ensured by changing the network configuration, thereby enhancing the mobility robustness.

In yet another embodiment of the present disclosure, sending the network parameter adjustment instruction to the base station includes: sending the network parameter adjustment instruction to the base station by carrying the network parameter adjustment instruction in a radio resource control signaling or a media access control layer signaling.

In this embodiment, the network configuration parameter between the base station and the terminal device can be adjusted based on the network parameter adjustment instruction by sending the network parameter adjustment instruction to the base station over a radio resource control signaling or a media access control layer signaling.

In yet another embodiment of the present disclosure, the radio resource control signaling is configured to send a measurement report or configured to send a radio link failure event.

In this embodiment, the network parameter adjustment instruction is transmitted over an existing radio resource control signaling configured to send a measurement report or a radio resource control signaling configured to send a radio link failure event, which facilitates the practice of the solution.

In yet another embodiment of the present disclosure, the method further includes: adjusting a network configuration parameter configured for the terminal device based on the network parameter adjustment instruction in response to sending the network parameter adjustment instruction to the base station; or adjusting a network configuration parameter configured for the terminal device based on the network parameter adjustment instruction in response to receiving an acknowledgement message from the base station, wherein the acknowledgement message is sent by the base station in response to receiving the network parameter adjustment instruction.

In one embodiment, the terminal device validates the network parameter adjustment instruction in response to sending the network parameter adjustment instruction to the base station, and then configures the network configuration parameter, which improves the network parameter configuring speed. In another embodiment, the terminal device validates the network parameter adjustment instruction in response to receiving an acknowledgement message from the base station, and then configures the network configuration parameter, avoiding subsequent data transmission problems caused by missing the network parameter adjustment instruction in transmission process.

In yet another embodiment of the present disclosure, adjusting the network configuration parameter configured for the terminal device based on the network parameter adjustment instruction includes at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In this embodiment, the network parameter adjustment instruction is executed by any one of the ways of activating a network configuration parameter from a predetermined network configuration parameter, or deactivating a network configuration parameter being used, or directly replacing a parameter value of the network configuration parameter being used, or increasing or decreasing the parameter value of the network configuration parameter. All of the four ways can realize adjustment of the network configuration parameter and are simple and convenient to realize.

In yet another embodiment of the present disclosure, increasing or decreasing the value of the network configuration parameter being used based on the network parameter adjustment instruction includes: acquiring a value set of a predetermined network configuration parameter; and selecting, from the value set of the predetermined network configuration parameter, a value adjacent to the value of the network configuration parameter being used according to an increasing or decreasing order.

In this embodiment, a value set of a network configuration parameter is predetermined, and then a value of the network configuration parameter is selected from the value set again in response to determining whether an adjustment direction instructed by the network parameter adjustment instruction is increased or decreased. The practice of changing values is simple.

According to a second aspect of the embodiments of the present disclosure, a method for configuring a network parameter is provided. The method includes: receiving a network parameter adjustment instruction by a base station from a terminal device; and adjusting a network configuration parameter between the base station and the terminal device based on the network parameter adjustment instruction.

In one embodiment of the present disclosure, receiving the network parameter adjustment instruction by the base station from the terminal device includes: receiving a radio resource control signaling or a media access control layer signaling from the terminal device, wherein the radio resource control signaling or the media access control layer signaling carries the network parameter adjustment instruction.

In another embodiment of the present disclosure, the radio resource control signaling is configured to send a measurement report or configured to send a radio link failure event.

In yet another embodiment of the present disclosure, adjusting the network configuration parameter between the base station and the terminal device based on the network parameter adjustment instruction includes at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In yet another embodiment of the present disclosure, increasing or decreasing the value of the network configuration parameter being used based on the network parameter adjustment instruction includes: acquiring a value set of a predetermined network configuration parameter; and selecting, from the value set of the predetermined network configuration parameter, a value adjacent to the value of the network configuration parameter being used according to an increasing or decreasing order.

In yet another embodiment of the present disclosure, the method further includes: sending an acknowledge message to the terminal device in response to receiving the network parameter adjustment instruction.

According to a third aspect of the embodiments of the present disclosure, an apparatus for configuring a network parameter is provided. The apparatus includes: a determining unit configured to, in response to a trigger event detected by a terminal device, determine a network parameter adjustment instruction based on the trigger event of the terminal device; and a sending unit, configured to send the network parameter adjustment instruction to a base station, the network parameter adjustment instruction instructing the base station to adjust a network configuration parameter between the base station and the terminal device.

In one embodiment of the present disclosure, the determining unit is configured to determine, based on a corresponding relationship between the trigger event and the network configuration parameter, a network configuration parameter corresponding to the trigger event of the terminal device; and determine the network parameter adjustment instruction based on the network configuration parameter and a network configuration parameter being used by the terminal device.

In another embodiment of the present disclosure, the trigger event includes a radio link failure event detected by the terminal device and a measurement event executed by the terminal device.

In yet another embodiment of the present disclosure, the sending unit is configured to send the network parameter adjustment instruction to the base station by carrying the network parameter adjustment instruction in a radio resource control signaling or a media access control layer signaling.

In yet another embodiment of the present disclosure, the radio resource control signaling is configured to send a measurement report or configured to send a radio link failure event.

In yet another embodiment of the present disclosure, the apparatus further includes: an adjusting unit, configured to adjust a network configuration parameter configured for the terminal device based on the network parameter adjustment instruction in response to sending the network parameter adjustment instruction to the base station; or adjust a network configuration parameter configured for the terminal device based on the network parameter adjustment instruction in response to receiving an acknowledgement message from the base station, wherein the acknowledgement message is sent by the base station in response to receiving the network parameter adjustment instruction.

In yet another embodiment of the present disclosure, the adjusting unit is configured to adjust the network configuration parameter by at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In yet another embodiment of the present disclosure, the adjusting unit is configured to acquire a value set of a predetermined network configuration parameter; and select, from the value set of the predetermined network configuration parameter, a value adjacent to the value of the network configuration parameter being used according to an increasing or decreasing order.

According to a fourth aspect of the embodiments of the present disclosure, an apparatus for configuring a network parameter is provided. The apparatus includes: a receiving unit, configured to receive a network parameter adjustment instruction from a terminal device; and an adjusting unit, configured to adjust a network configuration parameter between the base station and the terminal device based on the network parameter adjustment instruction.

In one embodiment of the present disclosure, the receiving unit is configured to receive a radio resource control signaling or a media access control layer signaling from the terminal device, wherein the radio resource control signaling or the media access control layer signaling carries the network parameter adjustment instruction.

In another embodiment of the present disclosure, the radio resource control signaling is configured to send a measurement report or configured to send a radio link failure event.

In yet another embodiment of the present disclosure, the adjusting unit is configured to adjust the network configuration parameter by at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In yet another embodiment of the present disclosure, the adjusting unit, configured to acquire a value set of a predetermined network configuration parameter; and select, from the value set of the predetermined network configuration parameter, a value adjacent to the value of the network configuration parameter being used according to an increasing or decreasing order.

In yet another embodiment of the present disclosure, the apparatus further includes: a sending unit, configured to send an acknowledge message to the terminal device in response to receiving the network parameter adjustment instruction.

According to a fifth aspect of the embodiments of the present disclosure, a device for configuring a network parameter is provided. The device includes: a processor; and a memory configured to store at least one instruction executable by the processor. The processor is configured to: in response to a trigger event detected by a terminal device, determine a network parameter adjustment instruction based on the trigger event of the terminal device; and send the network parameter adjustment instruction to a base station, the network parameter adjustment instruction instructing the base station to adjust a network configuration parameter between the base station and the terminal device.

According to a sixth aspect of the embodiments of the present disclosure, a device for configuring a network parameter is provided. The device includes: a processor; and a memory configured to store at least one executable by the processor. The processor is configured to: receive a network parameter adjustment instruction from a terminal device; and adjust a network configuration parameter between the base station and the terminal device based on the network parameter adjustment instruction.

According to a seventh aspect of the embodiments of the present disclosure, a computer-readable storage medium storing at least one instruction therein is provided. The at least one instruction, when loaded and executed by a processor of a device for configuring a network parameter, causes the device to perform the method for configuring a network parameter according to the first aspect.

According to an eighth aspect of the embodiments of the present disclosure, a computer-readable storage medium storing at least one instruction therein is provided. The at least one instruction, when loaded and executed by a processor of a device for configuring a network parameter, causes the device to perform the method for configuring a network parameter according to the second aspect.

It should be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of the description, illustrate embodiments of the present disclosure and, together with the description thereof, serve to explain the principles of the present disclosure.

FIG. 1 is a schematic diagram of a network frame according to an exemplary embodiment;

FIG. 2 is schematic diagram of a discontinuous reception (DRX) solution;

FIG. 3 is a flowchart of a method for configuring a network parameter according to an exemplary embodiment;

FIG. 4 is a flowchart of a method for configuring a network parameter according to another exemplary embodiment;

FIG. 5 is a flowchart of a method for configuring a network parameter according to yet another exemplary embodiment;

FIG. 6 is a schematic structural diagram of an apparatus for configuring a network parameter according to an exemplary embodiment;

FIG. 7 is a schematic structural diagram of an apparatus for configuring a network parameter according to another exemplary embodiment;

FIG. 8 is a block diagram of a device for configuring a network parameter according to an exemplary embodiment;

FIG. 9 is a block diagram of a device for configuring a network parameter according to another exemplary embodiment.

### DETAILED DESCRIPTION

Exemplary embodiments are described in detail here, examples of which are illustrated in the accompanying drawings. Where the following description hereinafter refers to the accompanying drawings, the same numbers in different accompanying drawings represent the same or similar elements, unless otherwise represented. The embodiments set forth in the following description of exemplary embodiments do not represent all embodiments consistent with the present disclosure. Instead, they are merely examples of apparatuses and methods consistent with some aspects related to the present disclosure as recited in the appended claims.

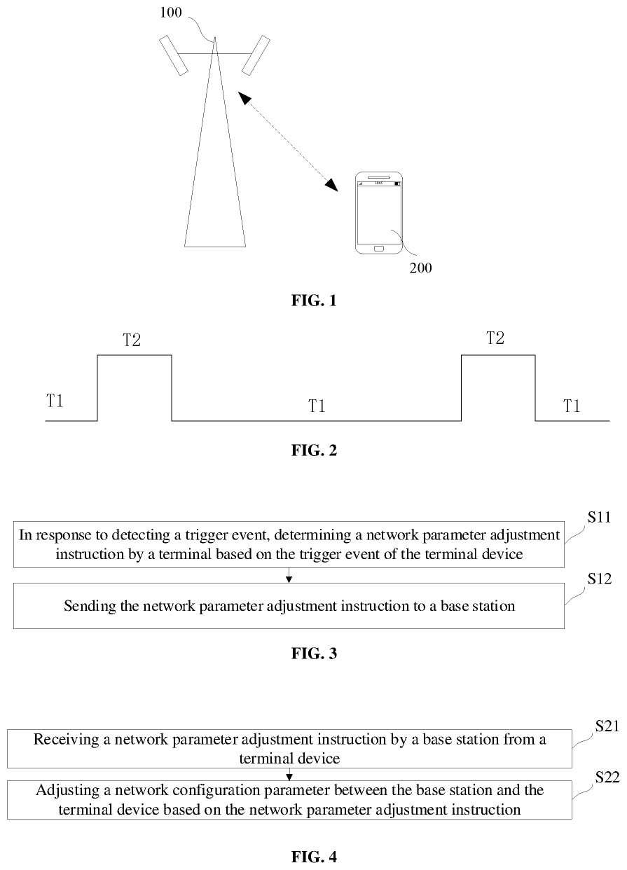

FIG. 1 is a schematic diagram of a network frame according to an exemplary embodiment of the present disclosure. Referring to FIG. 1, a base station 100 and a terminal device 200 use the same network parameter configuration for data transmission. For example, the base station 100 and the terminal device 200 are configured with the same discontinuous reception (DRX) periods to realize power-saving requirements of the terminal device. The terminal device includes but is not limited to a smart phone and a tablet. The base station may be an evolved NodeB (eNB).

FIG. 2 is schematic diagram of a DRX solution. Referring to FIG. 2, the terminal device periodically enters a dormant state. The terminal device does not need to perform physical downlink control channel (PDCCH) monitoring during a dormant time period T1. At the end of the dormant time period, the terminal device determines, by monitoring a PDCCH during a time period T2, whether the terminal device needs to be activated from the dormant state. A DRX period includes a dormant time period T1 and a monitoring time period T2. The same DRX periods need to be adopted by the base station and the terminal device to ensure normal data transmission therebetween. The DRX period is usually configured by the base station based on assistant information of the terminal device—power preference indication (PPI).

The configuration process of the DRX period is described hereinafter. The terminal device reports its PPI to the base station. The base station determines the DRX period for the terminal device based on the PPI, and then instructs the terminal device to configure the DRX period through a radio resource control (RRC) signaling. In this configuration, a user reports assistant information first, such that the entire network parameter configuring process is slow.

Accordingly, embodiments of the present disclosure provide a method and apparatus for configuring a network parameter, and a computer-readable storage medium, which can shorten the time required for configuring a network parameter.

FIG. 3 is a flowchart of a method for configuring a network parameter according to an exemplary embodiment of the present disclosure. This method may be performed by a terminal device. Referring to FIG. 3, the method includes the following processes.

In S11, in response to detecting a trigger event, the terminal device determines a network parameter adjustment instruction based on the trigger event of the terminal device.

In the embodiments of the present disclosure, the trigger event may indicate a change of assistant information of the terminal device. For example, when a user sets configuration information of the terminal device, if the PPI of the terminal device changes for example and the user sets the terminal device in a power-saving mode, the PPI is changed into power-saving; and when the user sets the terminal device in a non-power-saving mode, the PPI is changed into non-power-saving. At this time, the terminal device detects a trigger event, and then performs S11 and S12. The trigger event may be a radio link failure (RLF) event detected by the terminal device or a measurement event executed by the terminal device. When the radio network is weak, or the target cell is fully loaded, the terminal device detects an RLF event. In other words, the terminal device performs S11 and S12 in response to detecting a trigger event.

In this embodiment, if the trigger event indicates that a PPI of the terminal device is changed, a network configuration meeting the user's PPI may be determined based on this trigger event. If the trigger event is an RLF event detected by the terminal device or a measurement event executed by the terminal device, communication between the terminal device and the base station may be ensured by changing the network configuration, thereby enhancing the mobility robustness.

The terminal device stores corresponding relationships between various trigger events and network configuration parameters. The corresponding relationships may be sent by the base station to the terminal device, or may be directly defined in a network protocol.

In this process, the terminal device determines, based on a corresponding relationship between the trigger event and the network configuration parameter, a network configuration parameter corresponding to the trigger event of the terminal device, and determines the network parameter adjustment instruction based on the network configuration parameter and a network configuration parameter being used by the terminal device.

In this embodiment, the terminal device determines a network configuration parameter corresponding to the trigger event of the terminal device based on a pre-configured corresponding relationship between the trigger event and the network configuration parameter, and then determines the network parameter adjustment instruction based on the network configuration parameter and a network configuration parameter being used by the terminal device. This embodiment is simple and practical.

For example, change of the PPI into power-saving corresponds to a network configuration parameter having a relatively long DRX period, and change of the PPI into non-power-saving corresponds to a network configuration parameter having a relatively short DRX period, such that the user's PPI is met. A detected RLF event corresponds to a relatively short DRX period or deactivation of the DRX configuration (namely, the DRX technology is not used), such that the terminal device can receive instructions from the base station when a cell is switched.

The network parameter adjustment instruction includes instructions of: activating a predetermined network configuration parameter, deactivating a network configuration parameter being used, replacing a value of the network configuration parameter being used, and increasing or decreasing the value of the network configuration parameter being used.

The network parameter adjustment instruction may include a predetermined identifier of a network configuration parameter so as to instruct activation of the network configuration parameter corresponding to the identifier. Optionally, the network parameter adjustment instruction may include a deactivation identifier so as to instruct deactivation of the network configuration parameter being used. Optionally, the network parameter adjustment instruction may include a value of a network configuration parameter so as to instruct replacing of an existing value with the value of the network configuration parameter. Optionally, the network parameter adjustment instruction can include an instruction which may increase or decrease the value of the network configuration parameter being used so as to instruct increase or decrease of the value of the network configuration parameter being used based on the network configuration parameter being used.

Here, activating a predetermined network configuration parameter means configuring a network based on a predetermined network configuration parameter, such as performing DRX configuration using a first DRX period. Deactivating a network configuration parameter being used means not using the network configuration parameter being used, such as not using a second DRX period or stopping using the DRX function. Replacing a value of the network configuration parameter being used may specifically be replacing a DRX period being used with an instructed DRX period. Increasing or decreasing the value of the network configuration parameter being used may specifically be increasing or decreasing the DRX period.

For example, the trigger event is PPI. The terminal device stores a corresponding relationship between the PPI and the DRX period. The terminal device determines a DRX period corresponding to an acquired trigger event based on the corresponding relationship, compares a size of the determined DRX period and that of the DRX period being used by the terminal device, and determines to increase or decrease the value of the network configuration parameter being used based on the size relationship.

In S12, the network parameter adjustment instruction is sent to a base station, the network parameter adjustment instruction instructing the base station to adjust a network configuration parameter between the base station and the terminal device.

In the embodiments of the present disclosure, the network configuration parameter between the base station and the terminal device means a network configuration parameter configured for a communication connection established between the base station and the terminal device.

The network parameter adjustment instruction may be sent to the base station over a radio resource control signaling or a media access control layer signaling.

In the embodiments of the present disclosure, the terminal device determines the network parameter adjustment instruction based on the trigger event, and adjusts a network configuration parameter of the terminal device side based on the network parameter adjustment instruction. At the same time, the terminal device sends the determined network parameter adjustment instruction to the base station, such that the base station can also adjust the network configuration parameter between the base station and the terminal device based on the network parameter adjustment instruction, thereby realizing the same network parameter configurations of the base station and the terminal device to ensure data transmission. The solution does not require the terminal device to upload the trigger event prior to receiving the network parameter configuration instructed by the base station, thereby achieving a faster network configuration process.

Optionally, sending the network parameter adjustment instruction to the base station includes: sending the network parameter adjustment instruction to the base station by carrying the network parameter adjustment instruction in a radio resource control signaling or a media access control layer signaling.

In this embodiment, the network configuration parameter between the base station and the terminal device can be adjusted based on the network parameter adjustment instruction by sending the network parameter adjustment instruction to the base station over a radio resource control signaling or a media access control layer signaling.

The media access control layer signaling may be a protocol data unit (PDU) of a media access control (MAC) layer. The network parameter adjustment instruction may be carried in a control element (CE) field in the PDU of the MAC layer.

Optionally, the radio resource control signaling is configured to send a measurement report or configured to send an RLF event.

The measurement report may be of any type, such as one measurement report of A1-A6 and B1-B3.

In this embodiment, the network parameter adjustment instruction is transmitted over an existing radio resource control signaling configured to send a measurement report or a radio resource control signaling configured to send an RLF event, which facilitates the practice of the solution.

Optionally, the method further includes: adjusting a network configuration parameter configured for the terminal device based on the network parameter adjustment instruction in response to sending the network parameter adjustment instruction to the base station; or adjusting a network configuration parameter configured for the terminal device based on the network parameter adjustment instruction in response to receiving an acknowledgement message from the base station, wherein the acknowledgement message is sent by the base station in response to receiving the network parameter adjustment instruction and indicates that the base station determines to adjust the network configuration parameter of the base station based on the network parameter adjustment instruction.

In one embodiment, the terminal device validates the network parameter adjustment instruction in response to sending the network parameter adjustment instruction to the base station, and then configures the network configuration parameter, which improves the network parameter configuring speed. In another embodiment, the terminal device validates the network parameter adjustment instruction in response to receiving an acknowledgement message from the base station, and then configures the network configuration parameter, which avoids the situation where the base station fails to adjust the network configuration parameter based on the network parameter adjustment instruction due to missing of the network parameter adjustment instruction during transmission and hence subsequent data transmission is affected because the network configurations between the base station and the terminal device are different.

In this embodiment, “in response to sending the network parameter adjustment instruction to the base station” may specifically be “in response to transmitting the network parameter adjustment instruction to a lower layer;” and “in response to receiving an acknowledgement message from the base station” may specifically be “in response to receiving an acknowledgement message by the lower layer from the base station.”

When an RRC signaling is used to transmit the network parameter adjustment instruction, “in response to sending the network parameter adjustment instruction to the base station, adjusting a network configuration parameter configured for the terminal device based on the network parameter adjustment instruction” may specifically be “in response to transmitting the network parameter adjustment instruction to an RLC layer, adjusting a network configuration parameter configured for the terminal device based on the network parameter adjustment instruction;” and “in response to receiving an acknowledgement message from the base station” may specifically be “in response to receiving an acknowledgement (ACK) message from the RLC layer from the base station.”

When a PDU of a MAC layer is used to transmit the network parameter adjustment instruction, “in response to sending the network parameter adjustment instruction to the base station, adjusting a network configuration parameter configured for the terminal device based on the network parameter adjustment instruction” may specifically be “in response to transmitting the network parameter adjustment instruction to a physical layer, adjusting a network configuration parameter configured for the terminal device based on the network parameter adjustment instruction;” and “in response to receiving an acknowledgement message from the base station” may specifically be “in response to receiving a hybrid automatic repeat request acknowledgment (HARQ-ACK) message from the physical layer from the base station.”

Optionally, adjusting the network configuration parameter configured for the terminal device based on the network parameter adjustment instruction includes at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In this embodiment, the network parameter adjustment instruction is realized in four manners, namely by activating a network configuration parameter from a predetermined network configuration parameter, or by deactivating a network configuration parameter being used, or by directly replacing a parameter value of the network configuration parameter being used, or by increasing or decreasing the parameter value of the network configuration parameter. All of the four manners can realize adjustment of the network configuration parameter and are simple and convenient to realize.

Optionally, increasing or decreasing the value of the network configuration parameter being used based on the network parameter adjustment instruction includes: acquiring a value set of a predetermined network configuration parameter; and selecting, from the value set of the predetermined network configuration parameter, a value adjacent to the value of the network configuration parameter being used according to an increasing or decreasing order.

An example is described by taking a DRX period as a network configuration parameter. A DRX period value set of a predetermined network configuration parameter includes A, B, C, D, E, F and G in an ascending order. The DRX period value of a network configuration parameter being used by the terminal device is C. If the network parameter adjustment instruction instructs to increase the DRX period value of the network configuration parameter, the terminal device replaces the DRX period value with D.

In this embodiment, a value set of a network configuration parameter is predetermined, and then a value of the network configuration parameter is selected from a value set again in response to determining whether an adjustment direction instructed by the network parameter adjustment instruction is increased or decreased. The practice of changing values is simple.

It should be noted that processes S11 and S12 may be combined randomly with the above optional processes.

FIG. 4 is a flowchart of a method for configuring a network parameter according to another exemplary embodiment of the present disclosure. This method may be performed by a base station. Referring to FIG. 4, the method includes the following processes.

In S21, a base station receives a network parameter adjustment instruction from a terminal device.

The network parameter adjustment instruction is sent by the terminal device to the base station over a radio resource control signaling or a media access control layer signaling.

In S22, a network configuration parameter between the base station and the terminal device is adjusted based on the network parameter adjustment instruction.

The network parameter adjustment instruction instructs the base station to adjust a network configuration parameter between the base station and the terminal device. The adjustment may be practiced by: activating a predetermined network configuration parameter; deactivating a network configuration parameter being used; replacing a value of the network configuration parameter being used; or increasing or decreasing the value of the network configuration parameter being used. Here, activating a predetermined network configuration parameter may refer to configuring a network based on a predetermined network configuration parameter, such as performing DRX configuration using a first DRX period. Deactivating a network configuration parameter being used may refer to not using the network configuration parameter being used, such as not using a second DRX period or stopping using the DRX function. Replacing a value of the network configuration parameter being used may specifically be replacing a DRX period being used with an instructed DRX period. Increasing or decreasing the value of the network configuration parameter being used may specifically be increasing or decreasing the DRX period.

In the embodiments of the present disclosure, the terminal device determines the network parameter adjustment instruction through the trigger event, and adjusts a network configuration parameter of the terminal device side based on the network parameter adjustment instruction. At the same time, the terminal device sends the determined network parameter adjustment instruction to the base station, such that the base station can also adjust the network configuration parameter between the base station and the terminal device based on the network parameter adjustment instruction, thereby realizing the same network parameter configurations of the base station and the terminal device to ensure data transmission. The solution does not require the terminal device to upload the trigger event prior to receiving the network parameter configuration instructed by the base station, thereby achieving a faster network configuration process.

Optionally, receiving the network parameter adjustment instruction from the terminal device by the base station includes: receiving a radio resource control signaling or a media access control layer signaling from the terminal device, wherein the radio resource control signaling or the media access control layer signaling carries the network parameter adjustment instruction.

In this embodiment, the network configuration parameter between the base station and the terminal device can be adjusted based on the network parameter adjustment instruction by sending the network parameter adjustment instruction to the base station over a radio resource control signaling or a media access control layer signaling.

The media access control layer signaling may be a PDU of a MAC layer. The network parameter adjustment instruction may be carried in a CE field in the PDU of the MAC layer.

Optionally, the radio resource control signaling is configured to send a measurement report or configured to send an RLF event.

The measurement report may be of any type, such as one measurement report of A1-A6 and B1-B3.

In this embodiment, the network parameter adjustment instruction is transmitted over an existing radio resource control signaling configured to send a measurement report or a radio resource control signaling configured to send an RLF event, which facilitates the practice of the solution.

Optionally, adjusting the network configuration parameter between the base station and the terminal device based on the network parameter adjustment instruction includes at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In this embodiment, the network parameter adjustment instruction is realized in four manners, namely by activating a network configuration parameter from a predetermined network configuration parameter, or by deactivating a network configuration parameter being used, or by directly replacing a parameter value of the network configuration parameter being used, or by increasing or decreasing the parameter value of the network configuration parameter. All of the four manners can realize adjustment of the network configuration parameter and are simple and convenient to realize.

Optionally, increasing or decreasing the value of the network configuration parameter being used based on the network parameter adjustment instruction includes: acquiring a value set of a predetermined network configuration parameter; and selecting, from the value set of the predetermined network configuration parameter, a value adjacent to the value of the network configuration parameter being used according to an increasing or decreasing order.

In this embodiment, a value set of a network configuration parameter is predetermined, and then a value of the network configuration parameter is selected from a value set again in response to determining whether an adjustment direction instructed by the network parameter adjustment instruction is increased or decreased. The practice of changing values is simple.

Optionally, the method further includes: sending an acknowledge message to the terminal device in response to receiving the network parameter adjustment instruction.

In this embodiment, the base station sends an acknowledge message to the terminal device in response to receiving the network parameter adjustment instruction. The terminal device validates the network parameter adjustment instruction in response to receiving the acknowledgement message from the base station, and then configures the network configuration parameter, avoiding subsequent data transmission problems caused by missing the network parameter adjustment instruction in transmission process.

It should be noted that processes S21 and S22 may be combined randomly with the above optional processes.

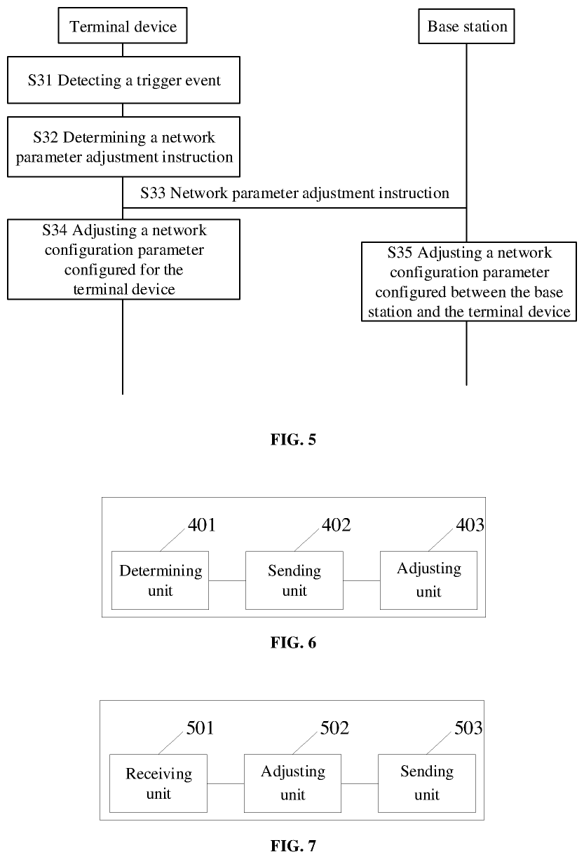

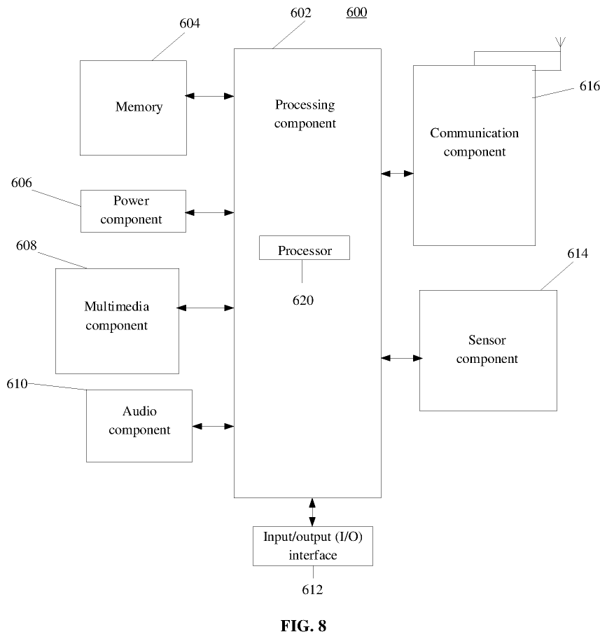

FIG. 5 is a flowchart of a method for configuring a network parameter according to yet another exemplary embodiment of the present disclosure. This method is performed by the terminal device and the base station together. Referring to FIG. 5, the method includes the following processes.

In S31, the terminal device detects a trigger event.

In the embodiments of the present disclosure, the trigger event may indicate a change of assistant information of the terminal device. For example, when a user sets configuration information of the terminal device, if the PPI of the terminal device changes for example and the user sets the terminal device in a power-saving mode, the PPI is changed into power-saving; and when the user sets the terminal device in a non-power-saving mode, the PPI is changed into non-power-saving. At this time, the terminal device detects a trigger event, and then performs subsequent processes. The trigger event may be an RLF event detected by the terminal device or a measurement event executed by the terminal device. When the radio network is weak, or the target cell is fully loaded, the terminal device detects an RLF event. In other words, the terminal device performs subsequent processes in response to detecting a trigger event.

Optionally, this method further includes: receiving, by the terminal device, a setting instruction for the terminal device input by a user, and changing assistant information according to the setting instruction for the terminal device. For example, the PPI is changed into power-saving in response to receiving a power-saving mode instruction for the terminal device.

In S32, in response to detecting a trigger event detected, the terminal device determines a network parameter adjustment instruction based on the trigger event of the terminal device.

The terminal device stores corresponding relationships between various trigger events and network configuration parameters.

In this process, the terminal device determines, based on a corresponding relationship between the trigger event and the network configuration parameter, a network configuration parameter corresponding to the trigger event of the terminal device, and determines the network parameter adjustment instruction based on the network configuration parameter and a network configuration parameter being used by the terminal device.

The network parameter adjustment instruction includes instructions of: activating a predetermined network configuration parameter, deactivating a network configuration parameter being used, replacing a value of the network configuration parameter being used, and increasing or decreasing the value of the network configuration parameter being used.

For example, change of the PPI into power-saving corresponds to a network configuration parameter having a relatively long DRX period, and change of the PPI into non-power-saving corresponds to a network configuration parameter having a relatively short DRX period, such that the user's PPI is met. A detected RLF event corresponds to a relatively short DRX period or deactivation of the DRX configuration (namely, the DRX technology is not used), such that the terminal device can receive instructions from the base station when a cell is switched.

Here, activating a predetermined network configuration parameter may refer to configuring a network based on a predetermined network configuration parameter, such as performing DRX configuration using a first DRX period. Deactivating a network configuration parameter being used may refer to not using the network configuration parameter being used, such as not using a second DRX period or stopping using the DRX function. Replacing a value of the network configuration parameter being used may specifically be replacing a DRX period being used with an instructed DRX period. Increasing or decreasing the value of the network configuration parameter being used may specifically be increasing or decreasing the DRX period.

For example, the trigger event is PPI. The terminal device stores a corresponding relationship between the PPI and the DRX period. The terminal device determines a DRX period corresponding to a trigger event acquired in S31 based on the corresponding relationship, compares a size of the determined DRX period and that of the DRX period being used by the terminal device, and determines to increase or decrease the value of the network configuration parameter being used based on the size relationship.

In S33, the network parameter adjustment instruction is sent by the terminal device to a base station, wherein the network parameter adjustment instruction instructs the base station to adjust a network configuration parameter between the base station and the terminal device. The base station receives the network parameter adjustment instruction from the terminal device.

Optionally, sending the network parameter adjustment instruction to the base station includes: sending the network parameter adjustment instruction to the base station by carrying the network parameter adjustment instruction in a radio resource control signaling or a media access control layer signaling.

In this embodiment, the network configuration parameter between the base station and the terminal device can be adjusted based on the network parameter adjustment instruction by sending the network parameter adjustment instruction to the base station over a radio resource control signaling or a media access control layer signaling.

The media access control layer signaling may be a PDU of a MAC layer. The network parameter adjustment instruction may be carried in a CE field in the PDU of the MAC layer.

Optionally, the radio resource control signaling is configured to send a measurement report or configured to send an RLF event.

The measurement report may be of any type, such as one measurement report of A1-A6 and B1-B3.

In this embodiment, the network parameter adjustment instruction is transmitted over an existing radio resource control signaling configured to send a measurement report or a radio resource control signaling configured to send an RLF event, which facilitates the practice of the solution.

Accordingly, the base station receives a corresponding signaling, and acquires the network parameter adjustment instruction from the received signaling.

In S34, the terminal device adjusts a network configuration parameter configured for the terminal device based on the network parameter adjustment instruction.

In response to sending the network parameter adjustment instruction to the base station, the terminal device adjusts a network configuration parameter configured for the terminal device based on the network parameter adjustment instruction; or adjusts a network configuration parameter configured for the terminal device based on the network parameter adjustment instruction in response to receiving an acknowledgement message from the base station, wherein the acknowledgement message is sent by the base station in response to receiving the network parameter adjustment instruction and indicates that the base station determines to adjust the network configuration parameter of the base station based on the network parameter adjustment instruction.

In one embodiment, the terminal device validates the network parameter adjustment instruction in response to sending the network parameter adjustment instruction to the base station, and then configures the network configuration parameter, which improves the network parameter configuring speed. In another embodiment, the terminal device validates the network parameter adjustment instruction in response to receiving an acknowledgement message from the base station, and then configures the network configuration parameter, which avoids the situation where the base station fails to adjust the network configuration parameter based on the network parameter adjustment instruction due to missing of the network parameter adjustment instruction during transmission and hence subsequent data transmission is affected because the network configurations between the base station and the terminal device are different.

When an RRC signaling is used to transmit the network parameter adjustment instruction, “in response to sending the network parameter adjustment instruction to the base station, adjusting a network configuration parameter configured for the terminal device based on the network parameter adjustment instruction” may specifically be “in response to transmitting the network parameter adjustment instruction to an RLC layer, adjusting a network configuration parameter configured for the terminal device based on the network parameter adjustment instruction;” and “in response to receiving an acknowledgement message from the base station” may specifically be “in response to receiving an ACK message from the RLC layer from the base station.”

When a PDU of a MAC layer is used to transmit the network parameter adjustment instruction, “in response to sending the network parameter adjustment instruction to the base station, adjusting a network configuration parameter configured for the terminal device based on the network parameter adjustment instruction” may specifically be “in response to transmitting the network parameter adjustment instruction to a physical layer, adjusting a network configuration parameter configured for the terminal device based on the network parameter adjustment instruction;” and “in response to receiving an acknowledgement message from the base station” may specifically be “in response to receiving an HARQ-ACK message from the physical layer from the base station.”

Optionally, adjusting the network configuration parameter configured for the terminal device based on the network parameter adjustment instruction includes at least one of: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In this embodiment, the network parameter adjustment instruction is realized in four manners, namely by activating a network configuration parameter from a predetermined network configuration parameter, or by deactivating a network configuration parameter being used, or by directly replacing a parameter value of the network configuration parameter being used, or by increasing or decreasing the parameter value of the network configuration parameter. All of the four manners can realize adjustment of the network configuration parameter and are simple and convenient to realize.

Optionally, increasing or decreasing the value of the network configuration parameter being used based on the network parameter adjustment instruction includes: acquiring a value set of a predetermined network configuration parameter; and selecting, from the value set of the predetermined network configuration parameter, a value adjacent to the value of the network configuration parameter being used according to an increasing or decreasing order.

An example is described by taking a DRX period as a network configuration parameter. A DRX period value set of a predetermined network configuration parameter includes A, B, C, D, E, F and G in an ascending order. The DRX period value of a network configuration parameter being used by the terminal device is C. If the network parameter adjustment instruction instructs to increase the DRX period value of the network configuration parameter, the terminal device replaces the DRX period value with D.

In this embodiment, a value set of a network configuration parameter is predetermined, and then a value of the network configuration parameter is selected from a value set again according to whether an adjustment direction instructed by the network parameter adjustment instruction is increased or decreased. The practice of changing values is simple.

In S35, the base station adjusts a network configuration parameter configured between the base station and the terminal device based on the network parameter adjustment instruction.

In this process, the base station adjusts the network configuration parameter at the network side in response to receiving the network parameter adjustment instruction from the terminal device. The process of adjusting the network configuration parameter by the base station is the same as that in S34.

FIG. 6 is a schematic structural diagram of an apparatus for configuring a network parameter according to an exemplary embodiment of the present disclosure. Referring to FIG. 6, the apparatus includes a determining unit 401 and a sending unit 402.

The determining unit 401 is configured to, in response to a trigger event detected by a terminal device, determine a network parameter adjustment instruction based on the trigger event of the terminal device. The sending unit 402 is configured to send the network parameter adjustment instruction to a base station, the network parameter adjustment instruction instructing the base station to adjust a network configuration parameter between the base station and the terminal device.

In one embodiment of the present disclosure, the determining unit 401 is configured to: determine, based on a corresponding relationship between the trigger event and the network configuration parameter, a network configuration parameter corresponding to the trigger event of the terminal device; and determine the network parameter adjustment instruction based on the network configuration parameter and a network configuration parameter being used by the terminal device.

In another embodiment of the present disclosure, the trigger event includes an RLF event detected by the terminal device and a measurement event executed by the terminal device.

In yet another embodiment of the present disclosure, the sending unit 402 is configured to: send the network parameter adjustment instruction to the base station by carrying the network parameter adjustment instruction in a radio resource control signaling or a media access control layer signaling.

In yet another embodiment of the present disclosure, the radio resource control signaling is configured to send a measurement report or configured to send an RLF event.

In yet another embodiment of the present disclosure, the apparatus further includes: an adjusting unit 403 configured to: adjust a network configuration parameter configured for the terminal device based on the network parameter adjustment instruction in response to sending the network parameter adjustment instruction to the base station; or adjust a network configuration parameter configured for the terminal device based on the network parameter adjustment instruction in response to receiving an acknowledgement message from the base station, wherein the acknowledgement message is sent by the base station in response to receiving the network parameter adjustment instruction.

In yet another embodiment of the present disclosure, the adjusting unit 403 is configured to adjust the network configuration parameter according to at least one of the following manners: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In yet another embodiment of the present disclosure, the adjusting unit 403 is configured to: acquire a value set of a predetermined network configuration parameter; and select, from the value set of the predetermined network configuration parameter, a value adjacent to the value of the network configuration parameter being used according to an increasing or decreasing order.

For details about determining the network parameter adjustment instruction by the determining unit 401, reference may be made to S32, and for details about sending the network parameter adjustment instruction by the sending unit 402, reference may be made to S33, which are not described herein any further.

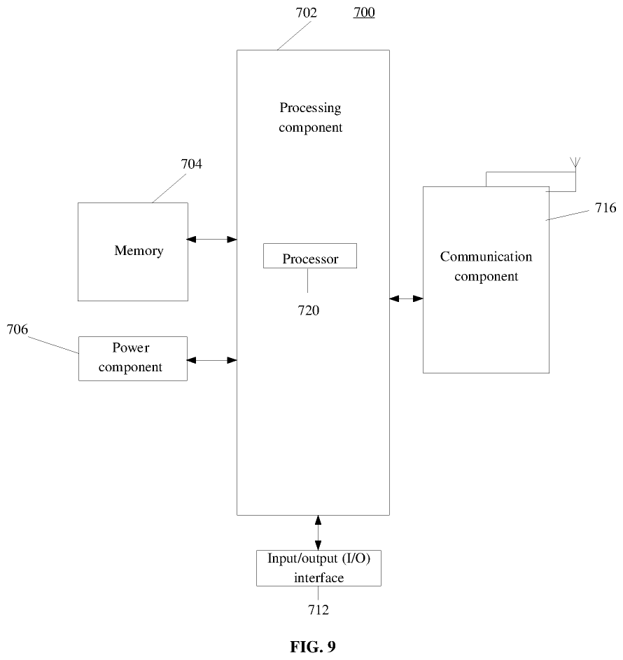

FIG. 7 is a schematic structural diagram of an apparatus for configuring a network parameter according to an exemplary embodiment of the present disclosure. Referring to FIG. 7, the apparatus includes a receiving unit 501 and an adjusting unit 502.

The receiving unit 501 is configured to receive a network parameter adjustment instruction from a terminal device. The adjusting unit 502 is configured to adjust a network configuration parameter between the base station and the terminal device based on the network parameter adjustment instruction.

In one embodiment of the present disclosure, the receiving unit 501 is configured to receive a radio resource control signaling or a media access control layer signaling from the terminal device, wherein the radio resource control signaling or the media access control layer signaling carries the network parameter adjustment instruction.

In another embodiment of the present disclosure, the radio resource control signaling is configured to send a measurement report or configured to send an RLF event.

In yet another embodiment of the present disclosure, the adjusting unit 502 is configured to adjust the network configuration parameter according to at least one of the following manners: activating a predetermined network configuration parameter based on the network parameter adjustment instruction; deactivating a network configuration parameter being used based on the network parameter adjustment instruction; replacing a value of the network configuration parameter being used based on the network parameter adjustment instruction; and increasing or decreasing the value of the network configuration parameter being used based on the network parameter adjustment instruction.

In yet another embodiment of the present disclosure, the adjusting unit 502 is configured to: acquire a value set of a predetermined network configuration parameter; and select, from the value set of the predetermined network configuration parameter, a value adjacent to the value of the network configuration parameter being used according to an increasing or decreasing order.

In yet another embodiment of the present disclosure, the apparatus further includes: a sending unit 503 configured to send an acknowledge message to the terminal device in response to receiving the network parameter adjustment instruction.

For details about sending and receiving the network parameter adjustment instruction by the receiving unit 501, reference may be made to S33, and for details about adjusting the network configuration parameter by the adjusting unit 502, reference may be made to S35, which are not described herein any further.

FIG. 8 is a block diagram of a device 600 for configuring a network parameter according to an embodiment. The device 600 may be the above-mentioned terminal device. Referring to FIG. 8, the device 600 for configuring a network parameter may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600 for configuring a network parameter, such as the operations associated with display, telephone calls, data communications, camera operations, and recording operations. The processing component 602 may include one or more processors 620 to execute instructions to perform all or part of the processes in the above-mentioned methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600 for configuring a network parameter. Examples of such data include instructions for any applications or methods operated on the device 600 for configuring a network parameter, contact data, phonebook data, messages, pictures, videos, or the like. The memory 604 may be implemented by using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600 for configuring a network parameter. The power component 606 may include a power management system, one or more power sources, and any other components associated with the generation, management, and distribution of power in the device 600 for configuring a network parameter.

The multimedia component 608 includes a screen providing an output interface between the device 600 for configuring a network parameter and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense the time duration and a pressure associated with the touch or swipe action. In some embodiments, the multimedia component 608 includes a front camera and/or a rear camera. The front camera and/or the rear camera may receive external multimedia data while the device 600 for configuring a network parameter is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (MIC) configured to receive external audio signals when the device 600 for configuring a network parameter is in an operation mode, such as a call mode, a recording mode, and a voice recognition mode. The received audio signals may be further stored in the memory 604 or transmitted via the communication component 616. In some embodiments, the audio component 610 further includes a speaker for outputting audio signals.

The I/O interface 612 provides an interface between the processing component 602 and peripheral interface modules, such as a keyboard, a click wheel, buttons, and the like. The buttons may include, but are not limited to, a home button, a volume button, a start button, and a lock button.

The sensor component 614 includes one or more sensors to provide status assessments of various aspects of the device 600 for configuring a network parameter. For instance, the sensor component 614 may detect an open/closed status of the device 600 for configuring a network parameter, relative positioning of components, e.g., the display device and the mini-keypad, of the device 600 for configuring a network parameter, a change in position of the device 600 for configuring a network parameter or a component of the device 600 for configuring a network parameter, a presence or absence of user contact with the device 600 for configuring a network parameter, an orientation or an acceleration/deceleration of the device 600 for configuring a network parameter, and a change in temperature of the device 600 for configuring a network parameter. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate wireless communication between the device 600 for configuring a network parameter and other devices. In embodiments of the present disclosure, the communication component 616 may access a wireless network based on a communication standard, such as 2G, 3G, 4G, 5G, or a combination thereof to realize network parameter configurations. In one exemplary embodiment, the communication component 616 receives a broadcast signal or broadcast associated information from an external broadcast management system via a broadcast channel. In one exemplary embodiment, the communication component 616 further includes a near field communication (NFC) module.

In exemplary embodiments, the device 600 for configuring a network parameter may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-mentioned methods for configuring a network parameter.

In exemplary embodiments, a non-transitory computer-readable storage medium including instructions is also provided, such as the memory 604 included instructions, executable by the processor 620 in the device 600 for configuring a network parameter, for performing the above-mentioned methods. For example, the non-transitory computer-readable storage medium may be a ROM, a RAM, a CD-ROM, a magnetic tape, a floppy disc, an optical data storage device, or the like.

FIG. 9 is a block diagram of a device 700 for configuring a network parameter according to an embodiment. The device 700 may be the above-mentioned base station. Referring to FIG. 9, the device 700 for configuring a network parameter may include one or more of the following components: a processing component 702, a memory 704, a power component 706, an input/output (I/O) interface 712 and a communication component 716.

The processing component 702 typically controls the overall operations of the device 700 for configuring a network parameter, such as the operations associated with display, telephone calls, data communications, camera operations, and recording operations. The processing component 702 may include one or more processors 720 to execute instructions to perform all or part of the processes in the above-mentioned methods. Moreover, the processing component 702 may include one or more modules which facilitate the interaction between the processing component 702 and other components. For instance, the processing component 702 may include a multimedia module to facilitate the interaction between a multimedia component 708 and the processing component 702.

The memory 704 is configured to store various types of data to support the operation of the device 700 for configuring a network parameter. Examples of such data include instructions for any applications or methods operated on the device 700 for configuring a network parameter, contact data, phonebook data, messages, pictures, video, or the like. The memory 704 may be implemented using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk.

The power component 706 supplies power to various components of the device 700 for configuring a network parameter. The power component 706 may include a power management system, one or more power sources, and any other components associated with the generation, management, and distribution of power in the device 700 for configuring a network parameter.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The communication component 716 is configured to facilitate wireless communication between the device 700 for configuring a network parameter and other devices. In embodiments of the present disclosure, the communication component 716 may provide a wireless network based on a communication standard, such as 2G, 3G, 4G, 5G, or a combination thereof to connect with a terminal device.

In exemplary embodiments, the device 700 for configuring a network parameter may be implemented with one or more application specific integrated circuits (ASICs), digital signal processors (DSPs), digital signal processing devices (DSPDs), programmable logic devices (PLDs), field-programmable gate arrays (FPGAs), controllers, micro-controllers, microprocessors, or other electronic components, for performing the above-mentioned methods for configuring a network parameter.

In exemplary embodiments, a non-transitory computer-readable storage medium including instructions is also provided, such as included in the memory 704, executable by the processor 720 in the device 700 for configuring a network parameter, for performing the above-mentioned methods. For example, the non-transitory computer-readable storage medium may be a ROM, a RAM, a CD-ROM, a magnetic tape, a floppy disc, an optical data storage device, or the like.

Other embodiments of the present disclosure are apparent to those skilled in the art from consideration of the specification and practice of the present disclosure. This disclosure is intended to cover any variations, uses, or adaptations of the present disclosure following the general principles thereof and including common knowledge or conventional technical means in the art which are not disclosed herein. The description and embodiments are to be considered as exemplary only, and the true scope and spirit of the present disclosure are subjected to the appended claims.

It will be understood that the present disclosure is not limited to the exact construction that has been described above and illustrated in the accompanying drawings, and that various modifications and changes may be made without departing from the scope thereof. The scope of the present disclosure is only subject to the appended claims.

1. A method for configuring a network parameter, comprising:
in response to detecting a trigger event, determining a network parameter adjustment instruction by a terminal device based on the trigger event; and
sending the network parameter adjustment instruction to a base station, the network parameter adjustment instruction instructing the base station to adjust a network configuration parameter between the base station and the terminal device.

2. The method according to claim 1, wherein determining the network parameter adjustment instruction by the terminal device based on the trigger event comprises:
determining, based on a corresponding relationship between the trigger event and the network configuration parameter, a network configuration parameter corresponding to the trigger event of the terminal device; and
determining the network parameter adjustment instruction based on the network configuration parameter and a network configuration parameter being used by the terminal device.

3. The method according to claim 1, wherein the trigger event comprises a radio link failure event detected by the terminal device and a measurement event executed by the terminal device.

4. The method according to claim 1, wherein sending the network parameter adjustment instruction to the base station comprises:
sending at least one of a radio resource control signaling or a media access control layer signaling to the base station, the at least one of the radio resource control signaling or the media access control layer signaling carrying the network parameter adjustment instruction.

5. The method according to claim 4, wherein the radio resource control signaling is configured to send a measurement report or configured to send a radio link failure event.

6. The method according to claim 1, further comprising:
adjusting, based on the network parameter adjustment instruction, a network configuration parameter configured for the terminal device in response to sending the network parameter adjustment instruction to the base station; or
adjusting a network configuration parameter configured for the terminal device based on the network parameter adjustment instruction in response to receiving an acknowledgement message from the base station, the acknowledgement message being sent by the base station in response to receiving the network parameter adjustment instruction.

7. The method according to claim 6, wherein adjusting, based on the network parameter adjustment instruction, the network configuration parameter configured for the terminal device comprises at least one of:
activating a predetermined network configuration parameter based on the network parameter adjustment instruction;
deactivating a network configuration parameter being used based on the network parameter adjustment instruction;
replacing a value of the network configuration parameter being used based on the network parameter adjustment instruction; and
increasing or decreasing the value of the network configuration parameter being used based on the network parameter adjustment instruction.

8. The method according to claim 7, wherein increasing or decreasing the value of the network configuration parameter being used based on the network parameter adjustment instruction comprises:
acquiring a value set of a predetermined network configuration parameter; and
selecting, from the value set of the predetermined network configuration parameter, a value adjacent to the value of the network configuration parameter being used according to an increasing or decreasing order.

9. A method for configuring a network parameter, comprising:
receiving a network parameter adjustment instruction by a base station from a terminal device; and
adjusting a network configuration parameter between the base station and the terminal device based on the network parameter adjustment instruction.

10. The method according to claim 9, wherein receiving the network parameter adjustment instruction by the base station from the terminal device comprises:
receiving a radio resource control signaling or a media access control layer signaling from the terminal device, the radio resource control signaling or the media access control layer signaling carrying the network parameter adjustment instruction.

11. The method according to claim 10, wherein the radio resource control signaling is configured to send a measurement report or configured to send a radio link failure event.

12. The method according to claim 9, wherein adjusting the network configuration parameter between the base station and the terminal device based on the network parameter adjustment instruction comprises at least one of:
activating a predetermined network configuration parameter based on the network parameter adjustment instruction;
deactivating a network configuration parameter being used based on the network parameter adjustment instruction;
replacing a value of the network configuration parameter being used based on the network parameter adjustment instruction; and
increasing or decreasing the value of the network configuration parameter being used based on the network parameter adjustment instruction.

13. The method according to claim 12, wherein increasing or decreasing the value of the network configuration parameter being used based on the network parameter adjustment instruction comprises:
acquiring a value set of a predetermined network configuration parameter; and
selecting, from the value set of the predetermined network configuration parameter, a value adjacent to the value of the network configuration parameter being used according to an increasing or decreasing order.

14. The method according to claim 9, further comprising:
sending an acknowledge message to the terminal device in response to receiving the network parameter adjustment instruction.

15.-28. (canceled)

29. A device for configuring a network parameter, comprising:
a processor; and
a memory for storing at least one instruction executable by the processor;
wherein the processor is configured to:
in response to a trigger event detected by a terminal device, determine a network parameter adjustment instruction based on the trigger event of the terminal device; and
send the network parameter adjustment instruction to a base station, the network parameter adjustment instruction instructing the base station to adjust a network configuration parameter between the base station and the terminal device.

30. A device for configuring a network parameter, comprising:
a processor; and
a memory for storing at last one instruction executable by the processor;
wherein the processor is configured to perform the method of claim 9.

31. A non-transitory computer-readable storage medium storing at last one instruction therein, wherein the at last one instruction, when loaded and run by a processor of a device for configuring a network parameter, causes the device to perform a method for configuring a network parameter according to claim 1.

32. A non-transitory computer-readable storage medium storing at last one instruction therein, wherein the at last one instruction, when loaded and run by a processor of a device for configuring a network parameter, causes the device to perform a method for configuring a network parameter according to claim 9.
